(19) United States
(12) Patent Application Publication
(10) Pub. No.: US 2016/0027070 A1
(43) Pub. Date: Jan. 28, 2016

(54) SYSTEM AND METHOD FOR WAREHOUSING OWNED ITEM VALUATIONS

(71) Applicant: Trov, Inc., Danville, CA (US)

(72) Inventors: Scott Allen Walchek, Danville, CA (US); Mark James Dowds, Alamo, CA (US); Jonathan Geoffrey Debonis, Walnut Creek, CA (US); David James Gemmell, San Ramon, CA (US)

(21) Appl. No.: 14/771,764

(22) PCT Filed: Mar. 13, 2014
(86) PCT No.: PCT/US2014/025501

§ 371 Date: Aug. 31, 2015

Related U.S. Application Data
(60) Provisional application No. 61/793,026, filed on Mar. 15, 2013.

(51) Int. Cl. G06Q 30/02; G06Q 40/02; G06Q 30/06; G06Q 10/08; G06Q 40/08

(52) U.S. Cl. CPC G06Q 30/0278; G06Q 10/087; G06Q 40/08; G06Q 30/0611; G06Q 40/025

(57) ABSTRACT

Described is a system that enables owners of tangible assets—owned items—to collect, secure and actively manage information about their valuable personal property. A database serves as a secure repository for valuations of owned items and related metadata, e.g., valuation appraisal certifications, item descriptions, locations, manuals, and photographs. These data are accessible by respective members via custom or general purpose user interfaces. The system receives data feeds that deliver information relevant to item valuations, derives updated valuations, and delivers valuation updates to the members.

### FIELD

The invention relates to a system and method for warehousing owned item valuations.

### BACKGROUND

Online tools are widely available for individuals to actively manage their personal wealth. Common examples include cloud-based banking, accounting, and investment tools and databases. In the aggregate, a considerable share of personal wealth is locked up in non-financial assets, however, such as jewelry, art and collectables, real estate, cars, boats and even appliances. Managing such tangible assets can be daunting.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 depicts a block diagram of a system 100 for warehousing owned item valuations.

FIG. 2 depicts a table 200 describing the contents of database 107 of FIG. 1 in accordance with one embodiment.

FIG. 3 depicts relational database tables 300 describing the contents of database 107 of FIG. 1 in accordance with another embodiment.

### DETAILED DESCRIPTION

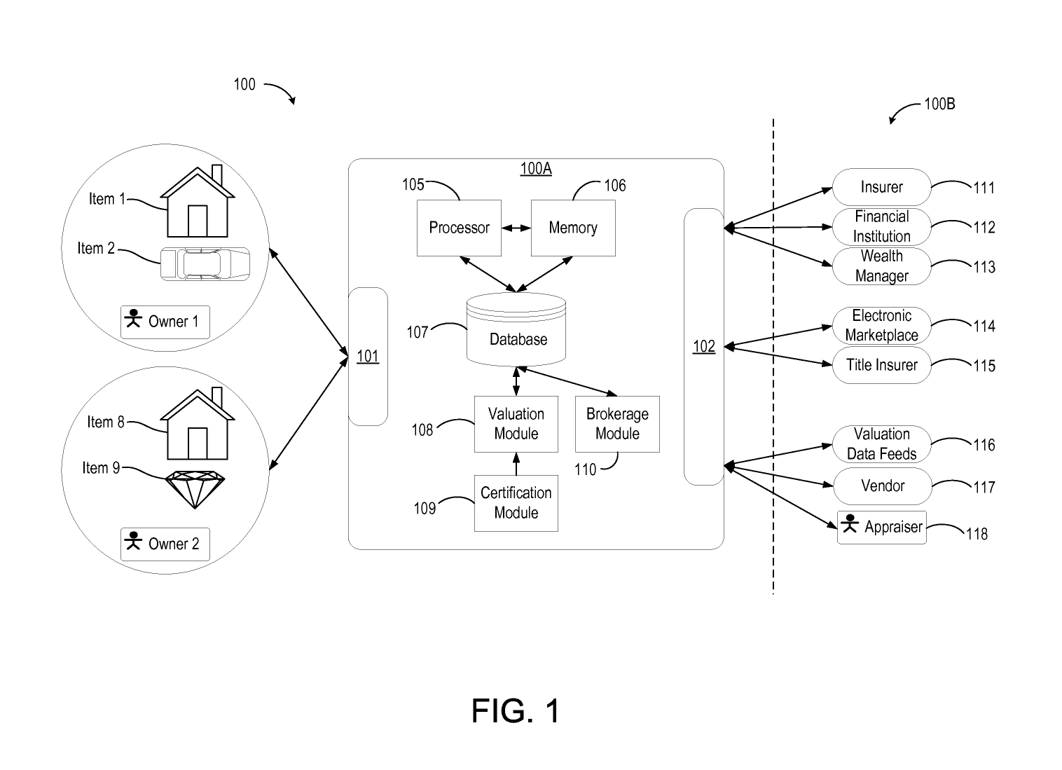

FIG. 1 depicts a block diagram of a system 100 that enables owners of tangible assets—owned items—to collect, secure and actively manage information about their valuable personal property. A server 100A serves as a secure repository for valuations of owned items and related metadata, e.g., valuation appraisal certifications, item descriptions, locations, manuals, and photographs. These data are accessible by respective owners Owner 1 (for Items 1 and 2) and Owner 2 (for Items 8 and 9), and allowed non-owners, via custom or general purpose user interfaces, such as smart-phone applications and Internet browsers. These communicate with server 100A through a first system interface 101. As detailed below, system 100 automatically updates changes in value, and curates content based on owned items to provide a relatively current view of personal wealth.

Server 100A is maintained by a service provider on behalf of members, owners Owner 1 and Owner 2 in this example. Server 100A includes a database 107 with a list of owners and, for each owner, a list of owned items and associated metadata. The metadata for each owned item includes a valuation, or possibly more than one (e.g., fair-market, wholesale, and replacement values). Server 100A transmits the list of owned items and the associated metadata to the respective owners, either when requested or automatically. Server 100A also includes a second system interface 102 that automatically communicates with various data feeds, often without human intervention, to receive valuation updates. System interfaces 101 and 102 are logical, and can be instantiated as one or more combinations of software and hardware resources.

A processor 105 within server 100A updates the metadata of the owned items responsive to the valuation updates. These updates can be derived from similar valuations in database 107, various types of data from a marketplace 100B external to system 100, and other factors such as the passage of time. Marketplace 100B, accessible via interface 102, includes e.g. insurers 111, financial institutions 112, wealth managers 113, electronic marketplaces 114 (e.g., EBAY), title insurers 115, valuation data feeds 116 (e.g., KELLEY BLUE BOOK, stock tickers), vendors 117, and appraisers 118. The service provider for system 100 can ensure that appraisers 118 are appropriately credentialed professionals. One or more of the types of entities included in external marketplace 100B can be controlled by the service provider.

In addition to database 107, server 100A includes a processor 105 and memory 106. Processor 105 executes software in memory 106 to support operations provided by various software modules, including a valuation module 108, a certification module 109, and brokerage module 110. The purposes of these modules are detailed below.

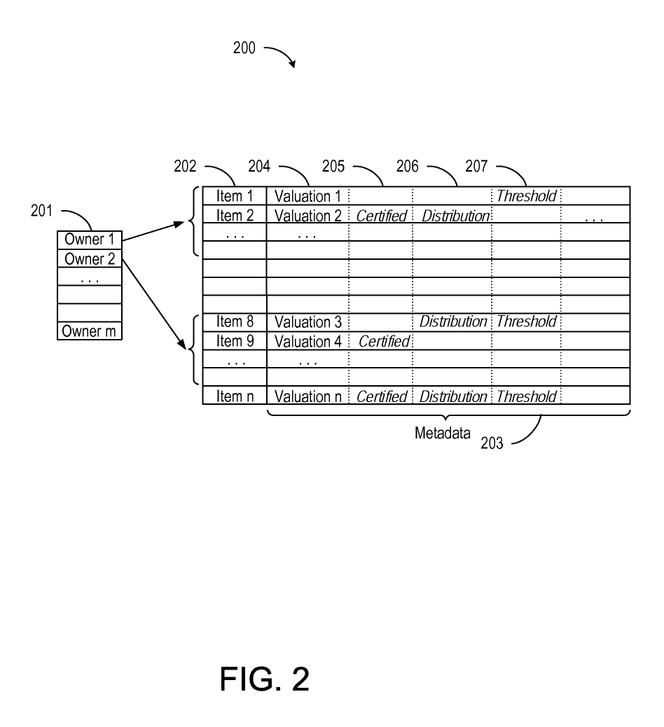

FIG. 2 depicts a data structure 200 that is stored in database 107 in one example. (In general, the first digit of numeric designations for elements identified in the drawings indicate the figure in which the element is introduced.) Data structure 200 includes a list of owners 201, and for each owner a set of owned items 202. Associated with each owned item is metadata 203, some of which provides or contributes to the valuation of the corresponding item. The illustrious metadata 203 includes a valuation 204, a certification 205, a distribution field 206, and a valuation threshold 207. Metadata can also include item location (e.g., which home, and specific location within the home).

Each item 202 is assigned a unique identifier. This identifier allows system 100 to maintain a provenance for each item independent of changes of ownership. Valuations 204 can be entered e.g. at time of purchase and are updated periodically or when new data becomes available. Valuation module 108 derives valuation updates based on information received from sources internal to system 100 or with reference to information from external marketplace 100B.

Assume, for example, that owner 2 is interested in maintaining a current valuation for item 9, a valuable diamond. Valuation field 204 might initially contain the purchase price, which is also stored in another field. Valuation module 108 may fetch or automatically receive updated valuation data from various internal and external sources. For example, brokerage module 110 can pass information derived from sales and offers within the community of owners maintained by system 100 to valuation module 108, and similar information may be obtained from e.g. electronic marketplace 114, valuation data feeds 116, vendors 117, and appraisers 118. Valuation module 108 derives a new valuation from these or other sources and updates valuation field 204.

Valuation data can take many forms for different types of items. In the example of item 9, a diamond, the metadata can include carat mass and other gemological characteristics, the site from which it was mined, indicia of proof of its appraised value, and images of related certificates. Such metadata is combined with updated valuation data from e.g. internal and external sales and offers to update valuation field 204.

Valuation data may also be based on the contents of certification field 205. Certification module 109, part of server 100A in this example, can reside elsewhere. For example, some embodiments support communication with certification modules that run on computers local to and under the control of appraisers 118. Module 109 authenticates appraisers 118 who have been vetted by the service provider to certify valuations. Such appraisers may require physical access to the item of interest. Certification field 205 can be populated with one of a range of values that reflect a degree of valuation confidence.

Brokerage module 110 facilitates changes of ownership between owners listed in database 107, and between such owners and entities in external marketplace 100B. Owners 1 and 2 can populate threshold fields 207 with trigger prices at which the owner is willing to sell the corresponding item. Brokerage module 110 can be configured to notify the owner of a buyer interested at the threshold price, or can automatically broker a sale. Brokerage module 110 can qualify buyers and sellers, and can manage exchanges between qualified buyers and sellers so that either or both parties can maintain anonymity.

Updated valuations offer benefits beyond being of interest to owners. For example, such information can be automatically transmitted to an insurer 111, possibly for a per-notice or subscription fee, who may respond by generating and delivering quotes reflecting the changed valuation. Insurance coverage can therefore be tailored to an owner's complex and evolving asset base. Valuation updates, including in the aggregate, can be conveyed to financial institutions 112 in support of owner financing requirements. Institutions can therefore make loan offers to owners based on tangible asset values. In this way, system 100 facilitates liquidity based on tangible assets.

Current valuations can be published to other types of third parties, such as to potential purchasers. In that case, the valuation may be scaled or increased by a factor (e.g., 120% of current valuation). Other third parties might include wealth managers, estate planners, and taxing authorities. Table 200 includes a distribution field 206 that specifies sharing options for all or a subset of the metadata.

Vendors 117 can facilitate the population of database 107 at point of purchase. A vendor 117 sends the price and related metadata, and related files, to system 100, e.g., via email, a direct data feed, or by posting the information to an ftp or http site for retrieval by system 100. Such information may include vendor identification (e.g., TIFFANY & CO., ZALES), purchase price, provenance, user manuals, certifications, and warranty information.

Valuation module 108 receives the information from a system interface (not shown), automatically determines a valuation, and in conjunction with processor 105, adds the item to table 201 of database 107. System 100 thus automatically populates metadata table 203 with a valuation update and related metadata, relieving owners of the burden of data entry. Although this process is automatic, the owner may enter purchase and metadata in some instances. In some embodiments, owners employ scanners or smart-phone applications that scan and otherwise accept purchase information and metadata to facilitate data entry. The service provider can employ or arrange for qualified appraisers or clerks to catalog owned items remotely or in situ.

At some point during the pendency of a sale transaction, one or both parties may require quotes for title insurance to be delivered to the offering party (e.g., an owner in the list of owners). Brokerage module 110 can automate the solicitation of quotes from title insurers 115. More generally, server 100A can support the solicitation of quotes for various purposes (e.g., for an airplane, automobile, artwork, insurance, maintenance, home security).

The service provider of system 100 may enter into financial relationships with participants in marketplace 100B to provide access or exposure to members and member data. For example, the service provider may sell or auction rights to permit advertisers to contact members, e.g., based on the contents of database 107, through targeted or other forms of advertising. Fees garnered from such relationships can be shared with members to entice participation.

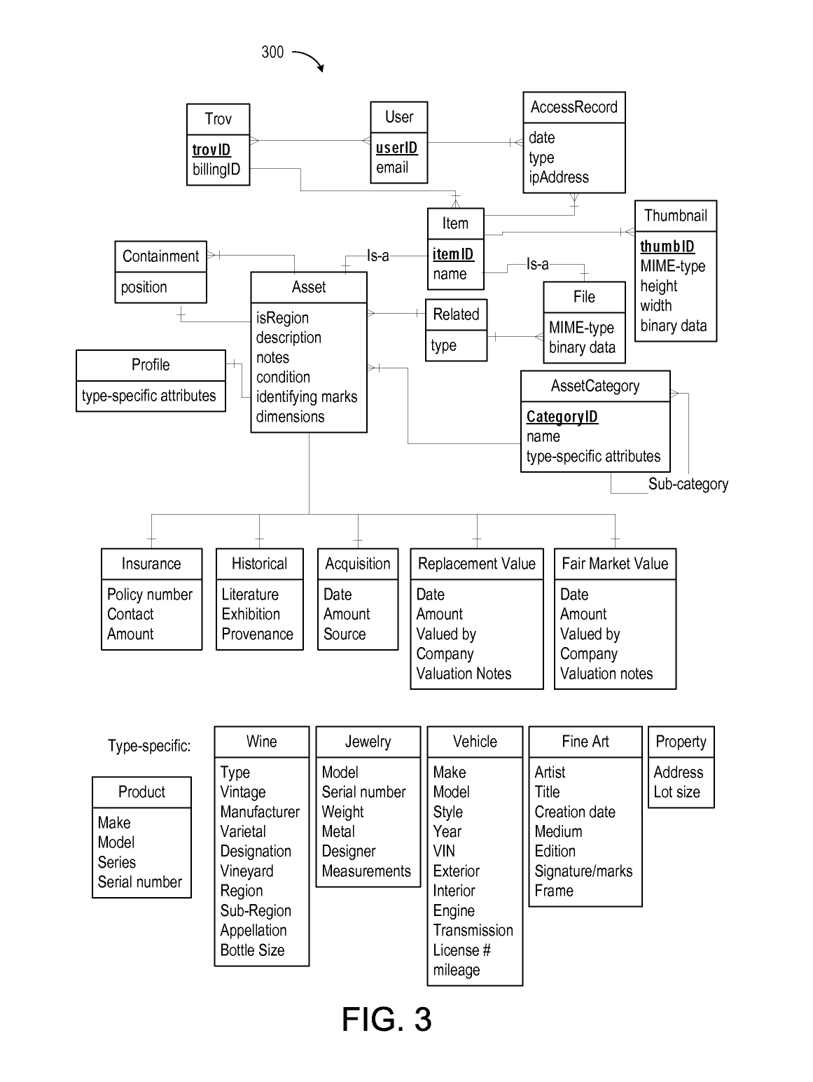

FIG. 3 depicts relational database tables 300 describing the contents of database 107 of FIG. 1 in accordance with another embodiment. In the description that follows, quoted names indicate the name of a table in FIG. 3. In this embodiment, the owner (denoted by the table entitled “Troy”) holds owned items (“Item”) in an account that includes real-world objects (“Asset”) and files relating to the real-world object (“File”), e.g., user manuals, certifications, warranty, photographs. The owner accesses his or her account by logging in with a user ID defined in table “User.” Other persons, e.g., a spouse, agent, or wealth manager, may access the same account with separate user IDs defined in “User.”

Exemplary categories of useful metadata that relate to owned items include descriptions, notes, conditions, identifying marks and dimensions, as depicted in the “Asset” table of FIG. 3. Additional examples of metadata common to owned items include the provenance of an item (“Historical” table), acquisition details (“Acquisition”), an insurance policy number, the amount of coverage and contact information (“Insurance” table), and replacement and fair market values. Category-specific metadata are also provided for in tables 300 of FIG. 3, for example details relating to wine, jewelry, vehicles, and fine art, which are useful for soliciting quotes for various purposes (e.g., for an airplane, automobile, artwork, insurance, maintenance, home security).

While the present invention has been described in connection with specific embodiments, other embodiments are contemplated. For example, Server 100A may be implemented as a discrete server in which a processor, memory, database, and modules are self-contained within a server having discrete physical boundaries. In this embodiment, communications among the processor, memory, database and modules occur internally. Server 100A may be implemented in a distributed fashion, e.g., VMWARE, in which the processor, memory, and database are not necessarily physically co-extensive. For example, processor 105 could be distributed across several physical processors communicating over a local area network. In such implementations, database 107 may be physically separate from processor 105 and memory 106, requiring communication over a potentially insecure link. Some embodiments therefore support secure links and data encryption for the contents of database 107. The components of server 100A can be distributed across local and wide-area networks, including the Internet, as will be readily understood by those of skill in the art.

Further variations will be obvious to those of ordinary skill in the art. Moreover, some elements are shown directly connected to one another while others are shown connected via intermediate components or interfaces. In each instance the method of interconnection establishes some desired communication between two or more elements. Such communication may often be accomplished using a number of topological configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. §112.

What is claimed is:

1. A system for facilitating liquidity of owned items, the system comprising:
server-side storage storing a database, the database including:
a list of owners; and
for each owner, a list of owned items and associated metadata, the metadata associated with each owned item including a valuation for the owned item;
a first system interface to transmit the list of owned items and the associated metadata to the respective owners; and
a second system interface to communicate with a data feed, the second interface automatically, without human intervention, receiving valuation updates;
a processor operable to update the metadata of the owned items responsive to the valuation updates;
wherein the first system interface transmits the valuation updates to a financial institution; and
wherein the system is operable to receive loan offers from the financial institution responsive to the valuation updates, and convey the loan offers to the owners of respective owned items.

2. The system of claim 1, wherein the metadata includes a field signifying whether the valuation is certified.

3. The system of claim 2, further comprising a certification module operable to authenticate an appraiser and to accept the valuation updates from the authenticated appraiser.

4. The system of claim 1, further comprising a valuation module operable to generate the valuation updates responsive to sales data.

5. The system of claim 1, the first system interface to transmit the valuation updates to an insurer.

6. The system of claim 5, the system operable to receive quotes from the insurer responsive to the valuation updates and convey the quotes to the owners of the respective owned items.

7. The system of claim 1, the first system interface to transmit the valuation updates to a third party.

8. The system of claim 1, the system operable to receive purchase data of an owned item.

9. The system of claim 1, wherein the metadata includes a distribution field to specify sharing options for subsets of the metadata.

10. The system of claim 1, further comprising a brokerage module operable to transmit and receive offers to purchase and sell owned items.

11. The system of claim 10, the system operable to transmit and receive offers to a third party electronic marketplace.

12. The system of claim 10, wherein the offer is anonymous.

13. The system of claim 10, the system operable to trigger the offer responsive to a valuation threshold.

14. The system of claim 10, the first system interface to transmit notice of the offer to purchase to title insurers.

15. The system of claim 14, the system operable to receive quotes from the title insurers responsive to the notice of the offer to purchase and convey the quotes to a source of the offer.

16. The system of claim 15, wherein the source of the offer is an owner.

17. A method for facilitating liquidity of owned items, the method comprising:
storing in a database:
a list of owners; and
a list of owned items and associated metadata, the metadata associated with each owned item including a valuation for the owned item;
associating each owned item with an owner;
transmitting the list of owned items and associated metadata to the respective owners;
communicating with a data feed and automatically, without human intervention, receiving valuation updates;
updating the metadata of the owned items responsive to the received valuation updates;
transmitting the valuation updates to a financial institution;
receiving loan offers from the financial institution responsive to the valuation updates; and
conveying the loan offers to the owners of respective owned items.

18. The method of claim 17, further comprising authenticating an appraiser and accepting valuation updates from the appraiser.

19. The method of claim 17, further comprising generating valuation updates responsive to sales data.

20. The method of claim 17, further comprising transmitting valuation updates to an insurer.

21. The method of claim 20, further comprising receiving quotes from the insurer responsive to the valuation updates and conveying the quotes to the owners of the respective owned items.

22. The method of claim 17, further comprising transmitting the valuation updates to a third party.

23. The method of claim 17, further comprising receiving purchase data of an owned item.

24. The method of claim 17, further comprising specifying subsets of the metadata to share.

25. The method of claim 17, further comprising transmitting and receiving offers to purchase and sell owned items.

26. The method of claim 25, further comprising transmitting and receiving the offers to a third party electronic marketplace.

27. The method of claim 25, wherein the offer is anonymous.

28. The method of claim 25, further comprising setting a valuation threshold in the metadata of the owned item and selectively triggering the offer responsive to the valuation threshold.

29. The method of claim 25, further comprising creating a notice of an offer to purchase and conveying that offer to title insurers.

30. The method of claim 29, further comprising receiving quotes from the title insurers responsive to the notice of an offer to purchase, and conveying the quotes to the offering party.

31. The method of claim 30, wherein the offering party is an owner.
